(19) United States
(12) Patent Application Publication
(10) Pub. No.: US 2024/0114114 A1
(43) Pub. Date: Apr. 4, 2024

(54) SYSTEM TO COLLECT IMAGE DATA FOR EXPRESSWAY INSPECTION

(71) Applicant: Central Nippon Expressway Company Limited, Nagoya-shi, Aichi (JP)

(72) Inventors: Atushi ONISHI, Nagoya-shi (JP); Toshiyuki MORI, Nagoya-shi (JP); Toshiki SAKAKIBARA, Nagoya-shi (JP)

(21) Appl. No.: 17/769,098

(22) PCT Filed: Apr. 14, 2021
(86) PCT No.: PCT/JP2021/015374

§ 371 Date: Apr. 14, 2022

(51) Int. Cl. H04N 7/18

(52) U.S. Cl. CPC H04N 7/181

(57) ABSTRACT

In the system to collect image data for expressway inspection according to the present invention, in an automobile running on an expressway, a local area network including a shooting means, a storage means, an image extraction means, a positional information acquisition means, and a wireless communication means is constructed. The shooting means shoots still images at predetermined time interval, and for each time the shooting is performed, outputs the obtained image data to the storage means. The storage means recognizes positional information acquired at the timing of shooting the image data from the positional information acquisition means as shooting location, and stores the image data in relation with the shooting location. The image extraction means has positional data of image extraction points, and from the storage means extracts the image data corresponding to the shooting location closest to the positional data of image extraction points, and then via the wireless communication means transmits the data of the still image to a data storage device not being mounted on the automobile but installed at a predetermined location.

### TECHNICAL FIELD

The present invention relates to a system to collect image data for road inspection wherein images used for inspection of the expressway, such as national highways and motorways, where the automobile travels at a high speed range, are collected.

### BACKGROUND OF THE INVENTION

In the work of checking the road surface condition of the road, the road surface area to be checked is extremely large, and the time that can be spent in determining the condition of a specific part is limited in order to cover the whole within a limited time. Then, in an inspection method wherein an inspector having a skill capable of evaluating the road surface condition visits a site of a road surface to be inspected and performs visual evaluation, the number of inspections is limited. Therefore, without visiting of an inspector to the site, an inspection using an image of the road surface as an inspection target obtained by shooting from a running vehicle has been attempted, and various techniques for collecting an image used for inspection have been proposed.

For example, in JPH10-294932, an image shooting apparatus for automatically shooting images of patrol places set in advance without any user's operation is proposed. Further, in JP2019-154017, a shot image pre-confirmation system, wherein shot states in shot images of road surface for inspection is confirmed at the time of shooting, and to inspection results using images affection of environmental conditions such as weather and illuminance or affection of shooting conditions such as a camera angle are prevented, is proposed.

### PRIOR ART DOCUMENTS

### Patent Document

Patent Document 1: JPH10-294932
Patent Document 2: JP2019-154017

### SUMMARY OF THE INVENTION

### Problem to be Solved by the Invention

However, inspections of expressways where automobiles travel at a high speed range, such as national highways and motorways, require high-resolution images at least 4K collected at high frequencies. Then, it was difficult to carry out the inspection of the expressway by the image by utilizing the conventional technology for collecting the image used for the inspection of the road.

Specifically, it is difficult in the prior art to shoot a still image at a specific point without an error in position while maintaining the running at a high speed range, and necessary images have to be collected by extracting a still image at a specific point from a video data, and then requirement of a large amount of time and work for processing the video data having a large data size become a problem for implementation. That is, since it is difficult to wirelessly transmit a video data having a large data size, it is troublesome to transfer data from the apparatus equipment mounted on the vehicle to the apparatus equipment at hand after all the video shooting are completed, and further, due to an increase in the data size of the video data, it takes a long time to perform processing such as transfer of data and extraction of a still image. If the frequency of image collection is increased, the work and time required for these processes exceed an acceptable range for implementation.

An objective of the present invention is to provide a system to collect image data for expressway inspection wherein inspection by images of the expressway the automobile travels at a high speed range can be implemented.

### Means to Solve the Problems

In the system to collect image data for expressway inspection according to the present invention, in an automobile running on an expressway, a local area network including a shooting means, a storage means, an image extraction means, a positional information acquisition means, and a wireless communication means is constructed. The shooting means shoots still images at predetermined time interval, and for each time the shooting is performed, outputs the obtained image data to the storage means. The storage means recognizes positional information acquired at the timing of shooting the image data from the positional information acquisition means as shooting location, and stores the image data in relation with the shooting location. The image extraction means has positional data of image extraction points, and from the storage means extracts the image data corresponding to the shooting location closest to the positional data of image extraction points, and then via the wireless communication means transmits the data of the still image to a data storage device not being mounted on the automobile but installed at a predetermined location.

The image extraction means may processes the still image data into a format that can be viewed through a browsing means set in a terminal device owned by a user of the still image data and transmits.

The local area network may include a plurality of the shooting means.

### Effect of the Invention

In the system to collect image data for expressway inspection according to the present invention, shooting still images at predetermined time intervals, for each time the shooting is performed, storing the obtained still image in relation to shooting location, and from the storage means extracting image data corresponding to shooting location closest to positional data of image extraction points, the image data of the image extraction point, i.e. the specific points, can be acquired. Further, only the extracted image data is transmitted to the data storage device not being mounted on the automobile via the wireless communication device. Therefore, even if the resolution of the still image to be shot is increased, the size of the image data at the required specific point is limited to an increase in the range that can be transmitted via the wireless communication device, and moreover, since the image data is transmitted via the wireless communication device to the data storage device not being mounted on the automobile, it is not necessary to transfer the data from the devices being mounted on the vehicle to the device at hand after the shooting operation is completed. Therefore, high-resolution images of expressways can be collected with high frequency and within an acceptable range of work and time for implementation, enabling the execution of inspections using images of expressways.

Further, in case wherein the image extraction means processes the image data into a format that can be viewed through a browsing means set in a terminal device owned by a user of the data of the still image data and transmits the processed image data, it is possible to accommodate situations wherein the acquired image must be immediately used.

Further, in the system to collect image data for expressway inspection according to the present invention, since a local area network (hereinafter, referred to as “in-vehicle LAN”) including a shooting means, a storage means, an image extraction means, a positional information acquisition means, and a wireless communication means is constructed in an automobile running on an expressway, even in case wherein a plurality of shooting means are included in the in-vehicle LAN, the shooting location of each shooting means can be synchronized by data exchanging via the in-vehicle LAN. Therefore, it is possible to accommodate situations wherein a plurality of high-quality images with different shooting angles are required, such as case wherein the road appendages are inspected in addition to the road surface.

### BRIEF DESCRIPTION OF THE DRAWINGS

FIG. 1 It is a block diagram showing an outline of an embodiment of the system to collect image data for expressway inspection according to the present invention.

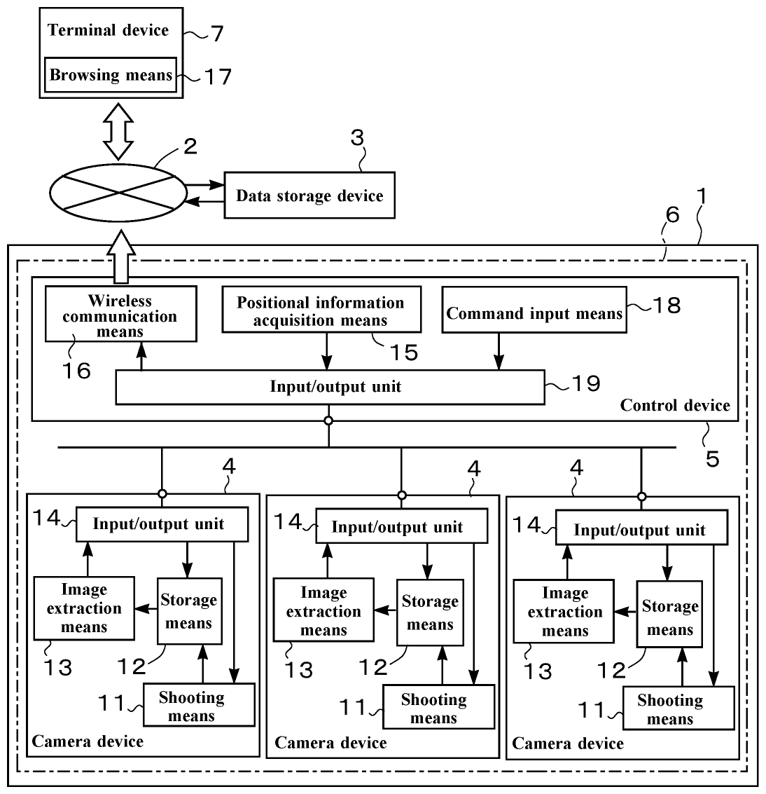

### EMBODIMENTS TO IMPLEMENT THE INVENTION

Embodiments of the system to collect image data for expressway inspection according to the present invention will be described with reference to the drawings.

This embodiment is for collecting inspection still images for use in the inspection of predetermined points on the expressway to be inspected. Still image for inspection is shot from the automobile 1 running on the expressway, and the image data is to be stored in the data storage device 3 via the Internet 2.

The automobile 1 is mounted with a camera device 4 having a shooting means 11, a storage means 12, and an image extraction means 13, and a control device 5 having an arithmetic processing unit for functioning as a positional information acquisition means 15 and a wireless communication means 16, and an in-vehicle LAN 6 including these devices is constructed. In this embodiment, three camera devices 4 are connected in order to enable shooting in three directions having different angles of view at predetermined shooting points. However, the number of the camera devices 4 is not limited, and may be a number accommodating the application or purpose.

The data storage device 3 is not being mounted on the automobile 1 and being installed in a predetermined location. The image data can be uploaded from the automobile 1 via the Internet 2, and the image data can be browsed using the terminal device 7 possessed by the user of the image data. In this embodiment, a known cloud server is employed as the data storage device 3.

The three camera devices 4 are composed of a shooting apparatus and a micro arithmetic processing apparatus, and are capable of exchanging data with apparatus and devices constituting an in-vehicle LAN 6 via an input/output unit 14 which is an interface. Shooting apparatus corresponds to the shooting means of the present invention, and each of the shooting means 11 of the three camera devices 4 is fixed at a different shooting angle to the automobile 1. In this embodiment, a commercially available 4K camera is used as the shooting means 11, but any other known image shooting device may be used as long as it has a function of shooting an image of a required image quality.

The micro arithmetic processing unit composing the camera device 4 functions as a storage means and an image extraction means of the present invention. In this embodiment, a known microcomputer is used as a micro arithmetic processing unit, but any other known arithmetic processing unit may be used as long as it can execute necessary processing.

Shooting means 11 is being to receive a shooting start command output from the control device 5, to start shooting the still image at predetermined time interval, and to output the obtained image data to the storage means 12 for each time the shooting is performed. The time interval for shooting still images may be appropriately set, taking into consideration the shooting conditions and the states of the inspection target, etc. Incidentally, the shooting of the still image is terminated by receiving a shooting end command output from the control device 5.

The storage means 12 receives the traveling positional information of the automobile 1 from the control device 5 at any time. Then, as the image data is output from the shooting means 11, at that timing, that is the timing when the image data has been acquired, the positional information acquired from the control device 5 is considered as the shooting location, and the image data is stored in relation with the shooting location.

The image extraction means 13 has positional data of the image extraction points, inquires of the storage means 12 about the shooting location according to a preset schedule, and extracts image data corresponding to the shooting location closest to the positional data of the image extraction point from the storage means 12. Then, the upload data processed into a format that can be viewed by the browsing means 17 set in the terminal device 7 owned by the user of the image data is uploaded to the data storage device 3 via the wireless communication means 16 of the control device 5.

In this embodiment, the file name of the image data is displayed as the link destination URL for each shooting point in the browsing means 17, and the file name of the image data is created according to a predetermined rule. The image extraction means 13 sets the name of the image data to be uploaded to the one following the rules. The file format is JPG. However, the format that can be viewed through the browsing means 17 is not limited, and may be appropriate depending on the function and usage environment of the terminal device 7 that is supposed to be used.

The control device 5 is being capable of exchanging data with the devices constituting the in-vehicle LAN 6 via the input/output unit 19 which is an interface. Further, it has a function as the positional information acquisition means 15 and the wireless communication means 16, and a function as a user interface for inputting a command to the shooting means 11.

The positional information acquisition means 15 acquires positional information of the automobile 1 by using GNSS, and transmits the information to a device connected to the in-vehicle LAN 6.

The wireless communication means 16 performs communication for uploading image data from the camera device 4 to the data storage device 3.

The command input means 18 includes a display for displaying an image. Then, by a touch operation on the drawing displayed on the display, a shooting start command or a shooting end command for the shooting means 11 is accepted, and the accepted command is output to the shooting means 11.

The in-vehicle LAN 6 connects the devices including the camera devices 4 and the control device 5 so as to be able to communicate with each other, and allows the addition and replacement of devices as required. In this embodiment, it is constructed by connecting a known LAN cable and a router using a TCP/IP protocol. However, it may be constructed by any other known method.

### DESCRIPTION OF SYMBOL

1 automobile
2 Internet
3 data storage device
4 camera device
5 control device
6 in-vehicle LAN
7 terminal device
11 shooting means
12 storage means
13 image extraction means
14, 19 input/output unit
15 positional information acquisition means
16 wireless communication means
17 browsing means
18 command input means

1. A system to collect image data for expressway inspection wherein:
in an automobile running on an expressway, a local area network including a shooting means, a storage means, an image extraction means, a positional information acquisition means, and a wireless communication means is constructed,
the shooting means shoots still images at predetermined time interval, and for each time the shooting is performed, outputs the obtained image data to the storage means,
the storage means recognizes positional information acquired at the timing of shooting the image data from the positional information acquisition means as shooting location, and stores the image data in relation with the shooting location,
the image extraction means has positional data of image extraction points, and from the storage means extracts the image data corresponding to the shooting location closest to the positional data of image extraction points, and then via the wireless communication means transmits the data of the still image to a data storage device not being mounted on the automobile but installed at a predetermined location.

2. The system to collect image data for expressway inspection according to claim 1, wherein the image extraction means processes the still image data into a format that can be viewed through a browsing means set in a terminal device owned by a user of the still image data and transmits.

3. The system to collect image data for expressway inspection of claim 1, wherein the local area network includes a plurality of the shooting means
